(19) United States
(12) Patent Application Publication
(10) Pub. No.: US 2009/0235248 A1
(43) Pub. Date: Sep. 17, 2009

(54) System and Method for Managing Virtual Hard Drives in a Virtual Machine Environment

(75) Inventor: Mark Conrad, Colorado Springs, CO (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Avocent Corporation, Huntsville, AL (US)

(21) Appl. No.: 12/266,639

(22) Filed: Nov. 7, 2008

Related U.S. Application Data
(60) Provisional application No. 60/996,232, filed on Nov. 7, 2007.

(51) Int. Cl. G06F 9/455

(52) U.S. Cl. 718/1

(57) ABSTRACT

Platform software is installed onto a native hardware platform (NHWP) containing a hard disk drive. That hard disk drive is formatted and structured as the NHWP would expect to use it to boot and run. However, the structure of that hard disk is converted to a drive image file (compressed or uncompressed) that can be loaded into a Virtual Machine Environment (VME). By mounting the drive image (or a partition of a drive image), the VME can use the partition as if it were a device rather than a file.

### CROSS REFERENCE TO CO-PENDING APPLICATION

The present application is related to and claims priority to U.S. Provisional Application Ser. No. 60/996,232, filed Nov. 7, 2007. The contents of that application are incorporated herein by reference in their entirety.

### FIELD OF INVENTION

The present invention is directed to a system and method for managing and/or using virtual disk drives in a Virtual Machine Environment (VME), and, in one embodiment, to a system and method for creating at least one disk drive volume in a Non-Virtual Machine Environment (NVME) and transferring an image of the at least one disk drive volume from the NVME to the VME such that the at least one drive volume can be used within the VME as a portion of a file system of the VME.

### DISCUSSION OF THE BACKGROUND

A number of Virtual Machine architectures exist, including, but not limited to, MICROSOFT VIRTUAL PC, PARALLELS WORKSTATION, VMWARE WORKSTATION, VIRTUAL IRON, and VIRTUALBOX. Using many of these systems, a user can create a Virtual Machine that runs on top of another operating system (e.g., WINDOWS (VISTA), LINUX and MAC OS) and assign resources to the Virtual Machine.

### BRIEF DESCRIPTION OF THE DRAWINGS

The following description, given with respect to the attached drawings, may be better understood with reference to the non-limiting examples of the drawings, wherein:

FIG. 1 is block diagram of partitions of a hard disk as they are created by an operating system for a NVME;

FIG. 2 is a screen dump showing a listing of a set of partitions corresponding to the partitions of FIG. 1;

FIG. 3 is a block diagram of a hard disk in a VME using a file that includes the partitions of the hard disk drive of the NVME of FIG. 1;

FIG. 4 is a screen dump showing a process of converting the set of partitions corresponding to the partitions of FIG. 1 into a drive image file that is then compressed into a compressed drive image file for transfer to a VME;

FIG. 5 is a screen dump showing a process of uncompressing the compressed drive image file of FIG. 4 back into a drive image file for use with the VME; and

FIG. 6 is a screen dump showing a process of linking a drive image file to a filesystem of the VME at a mount point.

### DISCUSSION OF THE PREFERRED EMBODIMENTS

A programmer or a systems engineer designs/creates platform software (e.g., an operating system, drivers, and application software) for a native HW platform (NHWP) (e.g., an x86-based version of the AVOCENT 5200 MERGE POINT SERVER MANAGEMENT SYSTEM or another server management unit) that is expected to be installed on a physical hard disk drive (present in the NHWP). That platform software is packaged into an installation format (e.g., an install CDROM (disk/ISO image), a DVD or bootable external drive (e.g., a USB-based hard disk drive or flash drive), or an installer executable file) that can be provided to the NHWP for installation.

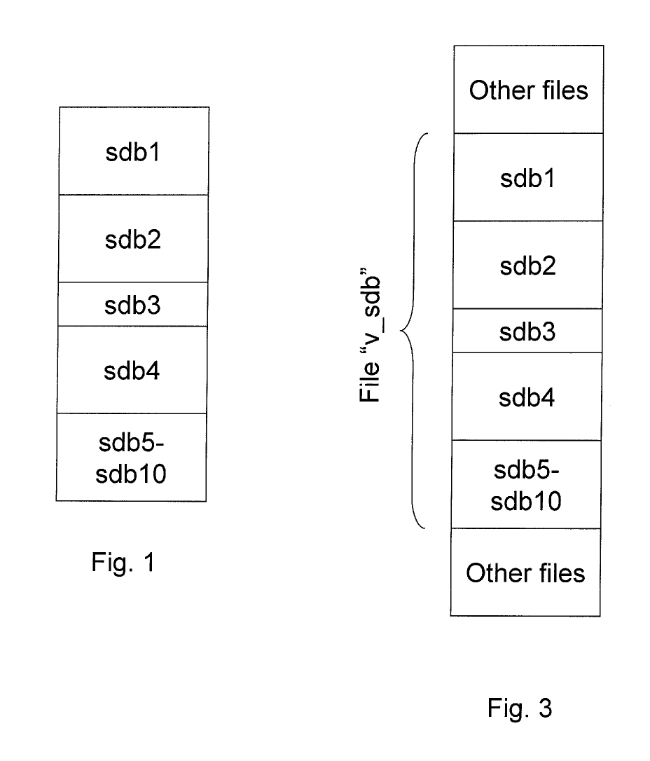

The installation format is then provided to a Native Hardware Platform (NHWP) that includes a hard disk drive onto which the platform software is to be installed. After installation of the platform software, the hard disk drive (HDD) of the NHWP will be formatted and contain at least one HDD partition (i.e., a division or slice of the HDD), as shown in FIG. 1. These HDD partitions (HDP) are accessed by operating system and application software running on the NHWP (e.g., through device nodes (e.g., /dev/sdb1, /dev/sdb2, . . ./dev/sdb10)). For example, a file system could be on one partition or device node (e.g. /dev/sdb2) which is accessed via a filesystem command to “mount” it (e.g., “mount -t cramfs /dev/sdb2/mnt/sdb1”). Other partitions (e.g., /dev/sdb1 may contain boot, operating, and initial RAM-based (e.g. ramdisk) filesystem object/images, and/or filesystem data. Depending on the operating system that created the HDD partitions, it is possible, without departing from the teachings of the present invention, that other device types or device names (e.g., “hdb” instead of “sdb”) may be used.

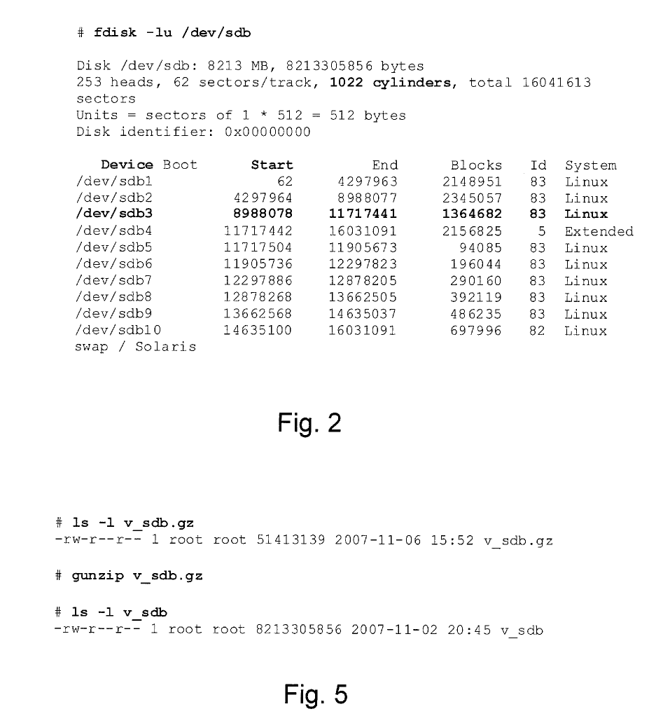

Further, other partitions (e.g. /dev/sdb4) may contain NHWP application code and/or application binary and non-binary data. As shown in FIG. 1, partitions sdb5-sdb10 are, for illustrative purposes only, shown as a single block because of their relatively small sizes. However, each such partition should be considered to be separate from the each other in their own partition, as shown in FIG. 2. As a result of the installation process, the NHWP (e.g., the x86-based MERGE POINT PLATFORM 5200) would be able to access the hard disk drive to boot the installed operating system (e.g. LINUX), mount its associates filesystem(s) and access the data on the partitions. In an exemplary embodiment with an 8 gigabyte hard drive, FIG. 2 is a screen dump showing a listing of a set of partitions resulting from an installation as one might see using the “fdisk” utility program.

The HDD from the NHWP can then be removed from the NHWP and connected (e.g., installed internally or connected as an external drive) to an intermediate manufacturing platform workstation (e.g. an x86-based PC running LINUX). Once connected, the entire contents of the HDD are copied to a file system of or accessible to the VME (running a compatible HW or emulated CPU as in the NHWP) as a file (e.g., v_sdb and/or v_hdb) as shown in FIG. 3. For example, the VME could emulate the x86-based MERGE POINT PLATFORM 5200 for which the platform software was written. The file when stored in the file system accessible to the VME need not be stored contiguously but instead may be fragmented as any other file in the VME, as long as the order when read from the file (using file system calls) is the same as the order of the actual hard disk.

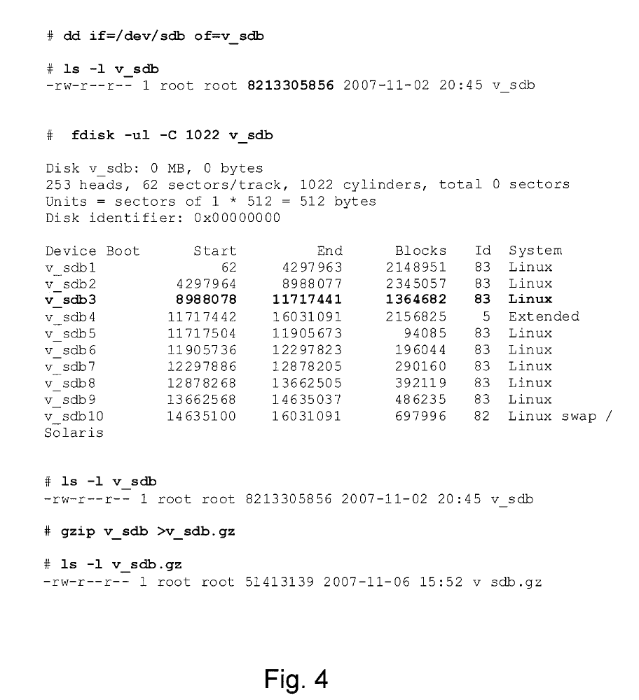

In one embodiment, the contents of the file (e.g., v_sdb or v_hdb) are copied directly to the VME or to a location accessible by the VME. In another embodiment, the contents are moved in compressed form to the VME (or to a location accessible by the VME) and uncompressed. Either the VME can uncompress the compressed file or another process can uncompress the compressed file and store it in a location accessible by the VME. In an exemplary compression-based method shown in FIG. 4, the entire contents (i.e., 8 gigabytes) of the HDD (shown in FIG. 1) are copied (e.g. using ‘dd’ or another equivalent device to file conversion utility) into a drive image file (e.g., named v_sdb or v_hdb) of the HDD. (The flags “if” and “of” refer to “input file” and “output file,” respectively.) The drive image file can then be compressed (e.g., using the “gzip” compression utility) into an identically reproducible compressed drive image file (e.g., named “v_sdb.gz” or “v_hdb.gz”, where “.gz” is the common file extension for files compressed by “gzip”). The resulting compressed drive image file is shown in FIG. 4 as a 50 megabyte file named “v_sdb.gz”. Using the VME or a location (e.g., a shared folder) which the VME can access, the compressed drive image file is made available to the VME (e.g., running the compatible HW or emulated CPU as in the NHWP). As shown in FIG. 5, the compressed drive image file is then uncompressed within the VME file system, thereby reproducing file the original drive image file (e.g., “v_sdb” or “v_hdb”).

The VME would then create emulated device nodes (and corresponding file system hard and soft links) for each partition found in the virtualized disk(s) (e.g., v_sdb and v_hdb). These partitions will be seen from programs such as fdisk as: v_sdb1, v_sdb2, . . . v_sdbN, and/or as v_hdb1. There will be a corresponding loopback (artificial/emulated) device node and file system hard link node for each of the partitions from the original HDD.

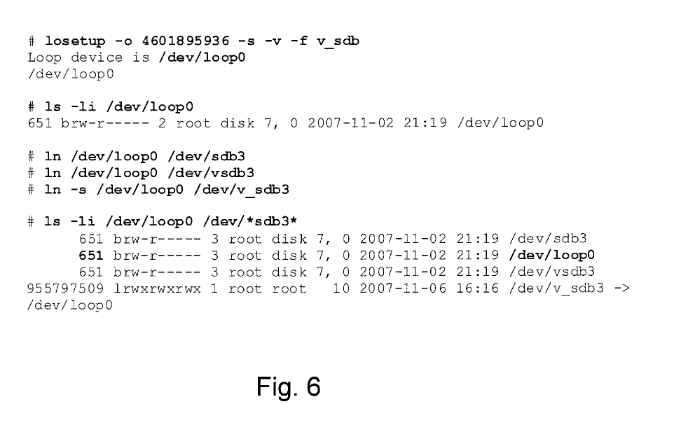

A loopback device node can be created and used using the ‘losetup’ utility program. To link an associated loopback device with several other equivalent devices, one can use the ‘ln’ utility program. For example, to create access to “v_sdb3” which corresponds to “/dev/sdb3”, one would calculate a location of “v_sdb3” within the file v_sdb. As was shown in FIG. 3, “v_sdb3” starts at sector 8988078 and ends at sector 11717441 and is 1364682 blocks long. To find the actual offset using 512 bytes per sector/block, one would calculate: 8988078 * 512=4601895936. Thus, as shown in FIG. 6, one could use the “losetup” command to create the /dev/loop0 loopback device. One would then be able to access the/dev/loop0 loopback device as is shown by requesting a listing of the characteristics of that device in FIG. 6. One would further be able to make other hard links (e.g., /dev/sdb3 and /dev/vsdb3) and soft links (e.g., /dev/v sdb3) to the same partition. This thereby associates former physical HDD partition /dev/sdb3 to several equivalent loopback (emulated/artifical/virtual) devices. Note that the /dev/loop3 device inode number (651) is identical to /dev/sdb3 and /dev/vsdb3.

The appropriate file system (types) can then be mounted against each of the corresponding (emulated/artificial) devices (e.g., mount—t ext3/dev/loop11/mnt/hdb1). After mounting, any remaining fixups (e.g., to v_sdb or v_hdb) that are needed to complete the emulated HDP environment within the VME can be applied, and the NHWP HDD will be transformed and running within the VME. For example, one can mount into the file system (at the mount point “/mnt/sdb3”) the loopback device using either “mount /dev/loop0/mnt/sdb3” or “mount /dev/sdb3/mnt/sdb3”. Both of these mounts are equivalent, and designed to make the underlying application code believe it is communicating with a real HDD.

The above invention can be used with any Management Protocol and/or device including IPMI, ILO and DRAC devices.

While certain configurations of structures have been illustrated for the purposes of presenting the basic structures of the present invention, one of ordinary skill in the art will appreciate that other variations are possible which would still fall within the scope of the appended claims.

1. A method of creating a virtual hard disk for use in a Virtual Machine Environment, the method comprising:
installing software onto a hard disk of a Native Hardware Environment including the hard disk;
converting a structure of the hard disk into a drive image file;
transferring the drive image to a location accessible by a Virtual Machine Environment; and
mounting at least one partition from the drive image into the Virtual Machine Environment such that at least one process of the Virtual Machine Environment can access the at least one partition at a mount point.

2. The method as claimed in claim 1, wherein transferring the drive image comprises transferring the drive image in uncompressed form to the location accessible by a Virtual Machine Environment.

3. The method as claimed in claim 1, wherein transferring the drive image comprises:
compressing the drive image into a compressed drive image;
transferring the compressed drive image to the location accessible by the Virtual Machine Environment; and
uncompressing the compressed drive image within the Virtual Machine Environment.

4. The method as claimed in claim 1, wherein transferring the drive image comprises:
compressing the drive image into a compressed drive image;
transferring the compressed drive image to the location accessible by the Virtual Machine Environment; and
uncompressing, outside of the Virtual Machine Environment, the compressed drive image to the location accessible by the Virtual Machine Environment.

5. The method as claimed in claim 1, wherein mounting the at least one partition from the drive image comprises:
creating a loopback device at an offset corresponding to the at least one partition; and
mounting the loopback device at the mount point.

6. The method as claimed in claim 1, wherein converting the structure of the hard disk into the drive image file comprises writing an entire contents of a device to a file.
